(19) United States
(12) Patent Application Publication
(10) Pub. No.: US 2008/0090196 A1
(43) Pub. Date: Apr. 17, 2008

(54) Dental cover and dental brace adapted for use with a cover

(76) Inventor: Omar David Lomas, Orange, CA (US)

Correspondence Address: ADORNO & YOSS, LLP, 1233 20th Street, NW, SUITE 703, WASHINGTON, DC, 20036, US

(21) Appl. No.: 11/546,561

(22) Filed: Oct. 12, 2006

(51) Int. Cl. A61C 7/08

(52) U.S. Cl. 433/6

(57) ABSTRACT

A dental cover and dental braces adapted for use with a cover for concealing a person's teeth and/or braces from view is provided. The dental cover has particular application as a device for hiding dental brace retainers while being worn, which many people find unattractive, or for covering aesthetic imperfections in a person's teeth. The dental cover may also be decorated and worn as a fashion accessory and may be provided separately.

The present invention generally relates to the field of dentistry and more particularly, is directed to a dental cover and dental braces adapted for use with a cover for concealing a person's teeth and/or braces from view.

The dental cover has particular application as a device for hiding dental braces while being worn or for covering aesthetic imperfections in a person's teeth. The dental cover may also be decorated and worn as a fashion accessory.

As used herein, the term “dental braces” refers to the devices that orthodontists use to straighten teeth. Such devices are also commonly referred to as “orthodontic braces” or “braces for straightening teeth.”

Most people are concerned about their personal appearance and are willing to take extreme measures to make them selves look more attractive. The cosmetic industry, for example, takes advantage of human vanity in this regard and has grown the sales of cosmetics to a multi-billion dollar a year enterprise. The cosmetic industry also is beginning to cater to men, while at the same time more aggressively marketing to their traditional female client base. In addition to cosmetics, many people consider weight loss diets, physical activity regimes, and for some, plastic surgical procedures, to be important options to consider in their ongoing effort to achieve and maintain a desired look.

For most people, a desired look includes a beautiful and attractive smile as an important attribute to their personal appearance. A person's teeth play an important role in achieving the perfect smile. Over time, teeth lose their natural white color due to aging, lack of regular brushing or other factors such as tobacco smoking. Teeth can also become stained by certain foods and beverages.

In the last several years, a number of teeth whitening products have come on to the market for the purpose of restoring teeth to their natural white color. These products appear to have little or no medical value, but have become very popular among the consuming public as an important addition to one's grooming routine. White teeth are presumed to be an indication of good health and hygiene and leads to a more pleasant smile.

Many teeth whitening products can be purchased over the counter for use by lay persons and others must be applied by a dentist or other health care professional. While these products generally work to whiten teeth, all of them suffer from a number of disadvantages.

First and foremost, over the counter teeth whitening products on the market today are expensive to buy and require several applications over many weeks to be effective. Professionally applied teeth whitening products work faster, but their application requires a visit to the dentist or other provider. Needless to say, professional application of these products can be very expensive and time consuming. In addition, teeth whitening products tend to fade over time and require re-application, thus adding to the overall cost of such products.

Many people are born with a near perfectly positioned set of teeth that remain that way over the course of their life. Other individuals are born with, or develop, teeth that are not so perfectly positioned. Poorly positioned teeth can lead to biting and chewing problems that become progressively worst over time. Such teeth also do not allow for an appealing smile. Thus, individuals who have poorly positioned teeth are candidates for orthodontic services. Such services often result in the need to wear dental braces for a period of time in order to reposition and straighten the teeth. Due to the expense of orthodontic services, the time involved and the unease that many people feel about going to the dentist, a number of people avoid having the work done altogether. In addition, most people who wear braces consider them to be unattractive and only wear them to correct significant orthodontic problems.

There are also a number of people whose teeth are only slightly out of position or crooked, but the time and expense of orthodontic services to correct the problem is not justified. Some individuals are also born with a gap between their two front teeth. The gap could be eliminated or reduced by dental braces, but again, many people do not do so because of the time and expense involved. Other individuals lose teeth due to extraction or injury. If the lost teeth are in the back of the mouth, the loss will have little aesthetic effect on the person's smile and appearance. However, if the loss is at or near the front of the mouth, there is a substantial aesthetic impact. The traditional approach to resolving this type of problem is by the installation of a dental cap or crown. Such a procedure can be very expensive, and thus, may not be available to everyone.

For the foregoing reasons, there is a need in the art for an improved method of addressing the problems of people who wish to conceal the fact that they are wearing dental braces, or who wish to correct for teeth that have lost their natural white color and/or to correct for teeth that are not properly positioned or that are missing.

It is therefore a primary objective of the present invention to provide a dental cover that can be worn in front of teeth to improve their aesthetic appearance.

It is further objective of the present invention to provide a dental cover that can be worn around the teeth to improve their aesthetic appearance.

It is another primary objective of the present invention to provide a dental brace which is formed with attachment points for attaching a dental cover which conceals the retainer wires around the teeth.

It is a still further objective of the present invention to provide a dental brace which is adapted to hold a dental cover for concealing the retainer wires around the teeth.

It is another objective of the present invention to provide a dental brace which is adapted to hold a decorative dental cover that can be worn in front of the teeth as a fashion accessory.

It is another objective of the present invention to provide a dental brace which is adapted to hold a decorative dental cover that can be worn around the teeth as a fashion accessory.

It is a still further objective of the present invention to provide a decorative dental cover that can be worn in front of teeth as a fashion accessory.

It is a still further objective of the present invention to provide a decorative dental cover that can be worn around teeth as a fashion accessory.

It is a further objective of the present invention to provide a dental cover that is easy to manufacture and economical to make which can be made available in mass to the consuming public.

It is a further objective of the present invention to provide a dental cover that appeals to the upscale and sophisticated taste of the consuming public.

It is another objective of the present invention to provide a dental cover that can be readily attached to the front of the teeth by the user.

It is another objective of the present invention to provide a dental cover that can be readily attached around the teeth by the user.

It is another objective of the present invention to provide a dental cover that prevents dental braces from causing injury to the mouth or at least minimizes or reduces injury to the mouth.

It is a still further objective of the present invention to provide a dental cover that prevents or minimizes injury to the mouth caused by dental braces, wherein the dental cover may or may not also be used as a fashion accessory.

It is another objective of the present invention to provide a dental cover that may be used to conceal missing teeth and can be color matched by the user to match the color of the user's existing teeth.

It is a still further objective of the present invention to provide a dental cover that may be used to conceal missing teeth with out concealing the surrounding teeth.

### SUMMARY OF THE INVENTION

The above and other objectives of the present invention are achieved by a device for covering the teeth and is adapted to attach to the teeth or to dental braces. Thus, the device of the invention can be used to address the problems of people who wish to conceal the fact that they are wearing dental braces or who wish to correct for teeth that have lost their natural white color and/or to correct for teeth that are not properly positioned or that are missing.

Thus, in accordance with the present invention, dental braces are designed with attachment points for the dental cover of the invention so that the unsightly wire retainers of the braces can be concealed. Braces with the attachment points and dental cover may be provided directly to the user.

For example, a dentist may provide to his or her orthodontic patients braces which include attachment points in accordance with the present invention and one or more dental covers at the time the orthodontic services are performed. Alternatively, braces with integrally formed attachment points may be provided to patients without the dental covers. The patient may then obtain the dental covers at a later time and/or from a separate source such as a retail outlet. In fact, a plurality of different style dental covers may be made available by retail outlets for braces with their integrally formed attachment points for the covers.

The dental cover of the present invention may also be attached directly to the teeth in order to conceal teeth that have lost their natural white color, teeth that are missing, or teeth that are out of position or crooked.

Whether worn in conjunction with dental braces or merely as a cover for the teeth, the dental cover of the present invention may be decorated in any number of designs and be worn as a fashion accessory.

### BRIEF DESCRIPTION OF THE DRAWINGS

These and other features, aspects, objectives, and advantages of the present invention will become better understood upon consideration of the following detailed description, appended claims and accompanying drawings where:

FIG. 1 is an elevation view of one example of dental braces and the dental cover of the present invention;

FIG. 2 is an alternative embodiment of the dental cover of the present invention; and

FIG. 3 illustrates a further embodiment of the dental cover of the present invention, wherein the dental cover is used to cover the front and back of a user's teeth.

### DESCRIPTION OF THE PREFERRED EMBODIMENT

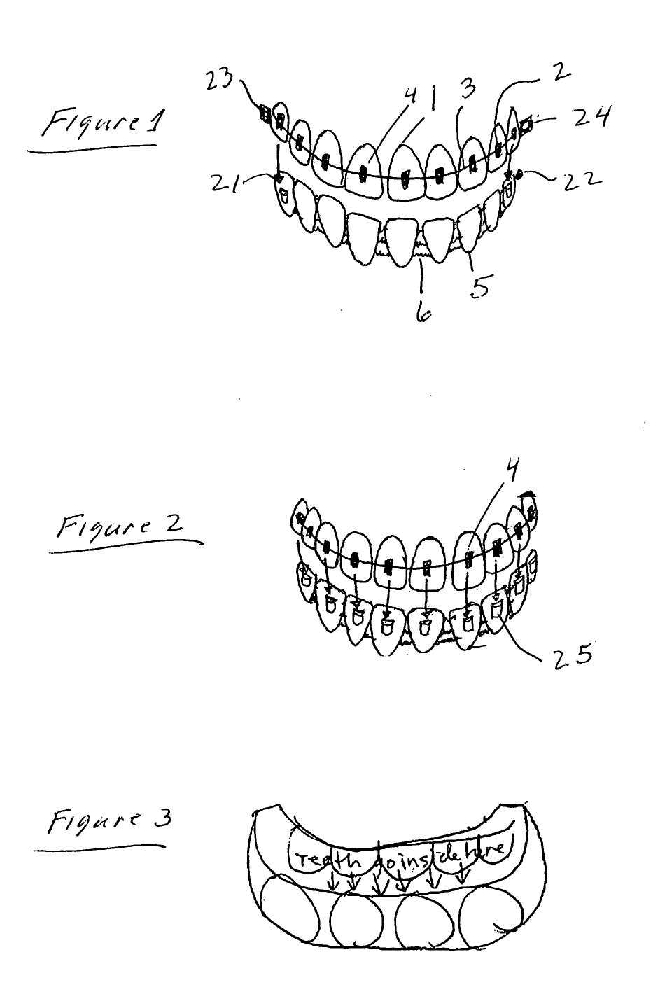

FIG. 1 illustrates one embodiment of a dental cover in accordance with the present invention. A shown in FIG. 1, a set of teeth 1 have a dental brace 2 installed around the teeth as is know in the art. As is typical with dental braces known in the art, the brace is formed with a wire retainer 3 that loops around each tooth. Due to the tension placed on each tooth by the retainer, the teeth are repositioned over time. Most dental braces known in the art also have some type of decorative feature or ornament 4 to enhance the aesthetic appeal of the braces.

Although ornament 4 improves the look of the braces, wire retainer 3 remains exposed to full view, and for many people present an unattractive appearance. The dental cover of the present invention addresses this problem.

FIG. 1 also illustrates the dental cover of the present invention. In the embodiment shown in FIG. 1, the dental cover is formed of a generally curved plate 6 with a plurality of tooth plates 5. Tooth plates 5 can be formed in a plurality of shapes and sizes and be positioned to match a set of human teeth. While plates 5 may be formed to resemble human teeth, the present invention is not so limited. Thus, plates 5 may be formed in a number of difference shapes and sizes without regard to the shape and size of human teeth.

In addition, tooth plates 5 may be formed slightly spaced apart from each other as illustrated in FIG. 1 or may be formed directly adjacent to each other. Tooth plates 5 may also be formed from one continuous piece of material with has a plurality of integrally formed tooth plates 5.

Plates 5 are held by carrier 6 which allows the dental cover to match the curved outer profile of a set of teeth. Carrier 6 may also be formed in a number of other styles and geometries. Carrier 6 and plates 5 may be formed of any material know in the art, including a light weight plastic. The material composition is unimportant so long as it has sufficient strength to maintain its shape and does not break up in the mouth.

The dental cover of the present invention also includes securing or attachment devices 21 and 22 which allow the cover to be attached to the braces at attachment points 23 and 24. Attachment devices 21 and 22 may be formed of a number of attachment devices known in the art, including clips, hangers, and like. These kinds of attachments are merely illustrative, and the invention is not limited to these forms of attachment. Alternatively, a number of attachments points along the dental cover may be formed for attaching the cover to the braces.

In the embodiment illustrated in FIG. 1, the dental cover is designed so that when installed, it conceals the entire braces from view, including the wire retainer.

FIG. 2 illustrates an alternative embodiment of the dental cover. In this embodiment, each of plates 5 have an aperture 25 through which ornament 4 shown in FIG. 1 may be seen. This adds an attractive appearance to the dental cover.

In accordance with the present invention, the dental cover may be provided by a dentist as an accessory for the braces. Thus, attachment points 23 and 24 illustrated in FIG. 1 are integrally formed with the braces when the braces are manufactured. The dental cover may also be sold separately as an after market item. As an after market item, the attachment means 21 and 22 illustrated in FIG. 1 are designed so that the cover could easily attach to the dental brace. Techniques for doing so are well within the capability of a person having ordinary skill in the art.

As pointed out above, the dental cover of the present invention may be formed from a number of materials known in the art and the invention is not limited to any particular material. Tooth plates 5 may be formed completely white in color to match the color of natural teeth. The cover may also be decorated in different colors and designs and worn as a fashion accessory. The invention is not limited to any particular color or aesthetic design of the dental cover. For example, the cover could be formed in the shape of hearts or other designs and decoration, such as precious stones and jewelry.

It should be understood that braces 3 illustrated in FIG. 1 can be provided with integral securing or attachment points 23 and 24 and the corresponding dental cover. Braces 3 and the dental cover may also be provided separately.

In addition to concealing dental braces, the dental cover of the present invention may also be used to conceal improperly placed or missing teeth as discussed above. In addition, the cover can completely eliminate the need to whiten natural teeth. The cover can be placed in front of the teeth and be held in place by attachment points 21 and 22. In this embodiment, attachments points 21 and 22 may simply be secured to one or more of the user's natural teeth in accordance with the knowledge of a person of ordinary skill in the art.

Thus, the dental cover of the invention may be used to eliminate the need to apply a whiting product to the teeth as well as to conceal missing teeth or teeth that are not properly positioned.

The dental cover of the present invention may be used to cover the front of a user's teeth as illustrated in FIG. 1 and as discussed above, or may be used to fully cover the front and back of a user's teeth as illustrated in FIG. 3. In the embodiment illustrated in FIG. 3, the dental cover may be formed out the same material as the cover illustrated in FIG. 1 and may be attached to dental braces and/or a user's teeth in the same manner.

Many dental braces cause cuts and abrasions to the insider of the wearer's mouth. Thus, an advantage of the embodiment of the dental cover illustrated in FIG. 3 is that the braces are covered, front and back, and thus prevent cuts and abrasions from occurring when the cover is used. When used for this purpose, the dental cover may be made of a transparent material when not being used for the additional purpose of making a fashion statement or to conceal the braces.

In another embodiment of the invention, the dental cover can be used to conceal missing teeth and can be color matched by the user to match the color of the user's existing teeth. In accordance with this embodiment of the invention, the dental cover can be made of a transparent material in those areas adjacent the missing teeth so that the user's teeth that are present are not concealed.

Although the present invention has been described in considerable detail with reference to certain preferred embodiments, one skilled in the art will appreciate that the present invention can be practiced by other than the preferred embodiments, which have been presented for purposes of illustration and not of limitation. Therefore, the spirit and scope of the appended claims should not be limited to the description of the preferred embodiments contained herein.

1. A dental cover adapted for being worn in the mouth to cover at least a portion of a user's teeth and adapted for use with dental braces, said dental cover comprising:
a cover that follows the approximate profile of a set of teeth; and
at least one securing device for securing said cover within said mouth.

2. The dental cover of claim 1, wherein said cover follows the outer profile of said teeth.

3. The dental cover of claim 1, wherein said cover follows the inner profile of said teeth.

4. The dental cover of claim 1, wherein said securing device is secured to said teeth.

5. (canceled)

6. (canceled)

7. The dental cover of claim 1, wherein said cover is formed in the appearance of a natural set of teeth.

8. The dental cover of claim 1, wherein said cover is formed of a plurality of sections, at least one of said sections having the appearance of a natural tooth.

9. The dental cover of claim 1, wherein said cover has a decorative appearance.

10. The dental cover of claim 1, wherein said cover has the appearance of a fashion accessory.

11. The dental cover of claim 1, wherein said cover is made of a plastic material.

12. The dental cover of claim 1, wherein said cover is made of a rubber material.

13. The dental cover of claim 1, wherein said cover is made of a ceramic material.

14. (canceled)

15. (canceled)

16. (canceled)

17. The dental cover of claim 1, wherein said cover helps to prevent injury caused by said braces to the inside of the user's mouth.

18. The dental cover of claim 1, wherein said securing device is adapted to be secured to said dental braces while said dental braces are being worn.

19. The dental cover of claim 18, wherein said cover conceals said dental braces from view.

20. The dental cover of claim 1, wherein said cover comprises:
a carrier; and
at least one tooth plate attached to said carrier.

21. (canceled)

22. (canceled)

23. (canceled)

24. (canceled)

25. The dental cover of claim 20, wherein said tooth plate is formed in the appearance of a natural tooth.

26. (canceled)

27. (canceled)

28. (canceled)

29. A dental brace adapted to receive a dental cover when said dental brace is being worn by a user, said dental brace comprising:
at least one retainer for retaining and repositioning said teeth;
at least one securing device for securing said dental cover within the mouth of the user when said dental braces are being worn.

30. The dental brace of claim 29, wherein said dental cover can be secured to said dental braces.

31. The dental cover of claim 1, wherein said cover is colored to match the color of the user's natural teeth.

32. The dental cover of claim 1, wherein said dental cover is made of a transparent material in those areas adjacent a user's missing teeth so that the user's teeth that are present are not concealed.
